(19) United States
(12) Patent Application Publication
(10) Pub. No.: US 2026/0101383 A1
(43) Pub. Date: Apr. 9, 2026

(54) ASSOCIATION PERIOD DETERMINATION FOR ADDITIONAL PHYSICAL RANDOM-ACCESS CHANNEL OCCASIONS

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Jae Ho RYU, San Diego, CA (US)

(21) Appl. No.: 19/346,154

(22) Filed: Sep. 30, 2025

Related U.S. Application Data
(60) Provisional application No. 63/703,167, filed on Oct. 3, 2024.

(51) Int. Cl. H04W 74/0833; H04L 5/14

(52) U.S. Cl. CPC H04W 74/0833; H04L 5/1438

(57) ABSTRACT

Methods, systems, and devices for wireless communications are described. A user equipment (UE) may receive a signal that identifies a configuration for a set of physical random-access channel (PRACH) occasions (ROs), wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs. The UE may selectively perform one or more PRACH transmissions during the first subset of ROs according to the one or more first parameters.

### CROSS REFERENCES

The present application for patent claims benefit of U.S. Provisional Patent Application No. 63/703,167 by ABDELGHAFFAR et al., entitled “ASSOCIATION PERIOD DETERMINATION FOR ADDITIONAL PHYSICAL RANDOM-ACCESS CHANNEL OCCASIONS,” filed Oct. 3, 2024, assigned to the assignee hereof, and expressly incorporated herein.

### FIELD OF TECHNOLOGY

The following relates to wireless communications, including association period determination for additional physical random-access channel occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a signal that identifies a configuration for a set of physical random-access channel (PRACH) occasions (ROs), where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs and selectively performing one or more PRACH transmissions during the first subset of ROs according to the one or more first parameters.

A UE for wireless communications is described. The UE may include one or more memories storing processor executable code, and one or more processors coupled with the one or more memories. The one or more processors may individually or collectively be operable to execute the code to cause the UE to receive a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs and selectively perform one or more PRACH transmissions during the first subset of ROs according to the one or more first parameters.

Another UE for wireless communications is described. The UE may include means for receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs and means for selectively performing one or more PRACH transmissions during the first subset of ROs according to the one or more first parameters.

A non-transitory computer-readable medium storing code for wireless communications is described. The code may include instructions executable by one or more processors to receive a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs and selectively perform one or more PRACH transmissions during the first subset of ROs according to the one or more first parameters.

In some examples of the method, UEs, and non-transitory computer-readable medium described herein, at least one RO of the additional ROs may include at least one sub-band full duplex (SBFD) symbol.

In some examples of the method, UEs, and non-transitory computer-readable medium described herein, a first quantity of additional ROs in the first subset of ROs may be less than a second quantity of ROs in the second subset of ROs.

In some examples of the method, UEs, and non-transitory computer-readable medium described herein, at least the association period associated with the first subset of ROs may be independent from a second subset of ROs association period and in accordance with a smallest integer of the second subset of ROs association period that satisfies a mapping cycle of ROs that may be mapped to synchronization signal block (SSB) transmissions.

In some examples of the method, UEs, and non-transitory computer-readable medium described herein, one or more ROs in the first subset of ROs that occur after an integer number of the mapping cycle include either non-mapped ROs that may be unavailable for PRACH transmissions or mapped ROs that may be available for PRACH transmissions according to a partial mapping cycle.

In some examples of the method, UEs, and non-transitory computer-readable medium described herein, at least the association period associated with the first subset of ROs may be a same association period as a second subset of ROs association period.

In some examples of the method, UEs, and non-transitory computer-readable medium described herein, a first quantity of ROs in the first subset of ROs fails to satisfy a mapping cycle and the first subset of ROs include non-mapped ROs that may be unavailable for PRACH transmission in accordance with the first quantity of ROs failing to satisfy the mapping cycle, and the mapping cycle corresponds to ROs that may be non-mapped to synchronization signal block (SSB) transmissions.

In some examples of the method, UEs, and non-transitory computer-readable medium described herein, a first quantity of ROs in the first subset of ROs fails to satisfy a mapping cycle threshold and the first subset of ROs include mapped ROs that may be available for PRACH transmission in accordance with a partial mapping cycle.

In some examples of the method, UEs, and non-transitory computer-readable medium described herein, a first quantity of additional ROs in the first subset of ROs may be more than a second quantity of ROs in the second subset of ROs.

In some examples of the method, UEs, and non-transitory computer-readable medium described herein, at least the association period associated with the first subset of ROs may be a same association period as a second subset of ROs association period.

In some examples of the method, UEs, and non-transitory computer-readable medium described herein, at least the association period associated with the first subset of ROs may be in accordance with an integer value associated with a second subset of ROs association period.

Some examples of the method, UEs, and non-transitory computer-readable medium described herein may further include operations, features, means, or instructions for receiving an indication of at least the association period associated with the first subset of ROs, where the indication identifies whether a same association period or different association periods may be used for the first subset of ROs and the second subset of ROs.

In some examples of the method, UEs, and non-transitory computer-readable medium described herein, at least the association period associated with the first subset of ROs may be in accordance with a ratio between a first quantity of additional ROs in the first subset of ROs and a second quantity of ROs in the second subset of ROs.

In some examples of the method, UEs, and non-transitory computer-readable medium described herein, at least the association period associated with the first subset of ROs may be in accordance with a minimum quantity associated with a second subset of ROs association period that satisfies a mapping cycle threshold.

In some examples of the method, UEs, and non-transitory computer-readable medium described herein, a third subset of ROs within the first subset of ROs occur after an integer number of association periods associated with the first subset of ROs.

In some examples of the method, UEs, and non-transitory computer-readable medium described herein, ROs in the third subset of ROs may be not non-mapped to synchronization signal block (SSB) transmissions and may be not available for PRACH transmissions.

In some examples of the method, UEs, and non-transitory computer-readable medium described herein, ROs in the third subset of ROs may be available for PRACH transmissions in accordance with the first subset of ROs satisfying a mapping cycle threshold.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports association period determination for additional physical random-access channel (PRACH) occasions (ROs) in accordance with one or more aspects of the present disclosure.

FIGS. 2A and 2B show examples of a RO configuration that supports association period determination for additional ROs in accordance with one or more aspects of the present disclosure.

FIGS. 3A and 3B show examples of a RO configuration that supports association period determination for additional ROs in accordance with one or more aspects of the present disclosure.

FIGS. 4A and 4B show examples of a RO configuration that supports association period determination for additional ROs in accordance with one or more aspects of the present disclosure.

FIG. 5 shows an example of a RO configuration that supports association period determination for additional ROs in accordance with one or more aspects of the present disclosure.

FIGS. 6 and 7 show block diagrams of devices that support association period determination for additional ROs in accordance with one or more aspects of the present disclosure.

FIG. 8 shows a block diagram of a communications manager that supports association period determination for additional ROs in accordance with one or more aspects of the present disclosure.

FIG. 9 shows a diagram of a system including a device that supports association period determination for additional ROs in accordance with one or more aspects of the present disclosure.

FIGS. 10 and 11 show flowcharts illustrating methods that support association period determination for additional ROs in accordance with one or more aspects of the present disclosure.

### DETAILED DESCRIPTION

Wireless networks may use physical random-access channel (PRACH) occasions (ROs) to enable a user equipment (UE) to establish a connection with the network. For example, the UE may use the resources (e.g., the time, frequency, spatial, or other) of the ROs to perform PRACH transmissions to initiate the connection with the network to perform wireless communications. In some aspects, legacy ROs are configured (e.g., via a configuration indicated in a system information block (SIB), such as a SIB1 message) for the UE to use where the ROs are mapped to synchronization signal block (SSB) transmissions. However, some UE may be capable of or otherwise support subband full-duplex (SBFD) (e.g., SBFD aware UEs) communications where a time period (e.g., symbol(s), slot(s), subframe(s), etc.) includes frequency resources available for both uplink and downlink communications (e.g., the frequency resources are divided into uplink and downlink subbands). Accordingly, in some aspects, a configuration for ROs may include legacy ROs as well as additional ROs that are available for such SBFD aware UE to enable random access procedures in SBFD symbols. However, such wireless networks may not provide a mechanism to fully configure the additional ROs for some UE such that the UE are able to determine the parameter(s) of the additional ROs.

Accordingly, aspects of the techniques described herein provide various mechanisms for UE to be able to identify or otherwise determine various parameter(s) of the additional ROs that are or may be available for PRACH transmissions. For example, the UE may receive or otherwise obtain a signal that identifies a configuration for a set of ROs. In some aspects, first parameter(s) associated with a first subset of ROs (e.g., the additional ROs) in the set of ROs may be in accordance with or otherwise based on second parameter(s) associated with a second subset of ROs (e.g., the legacy ROs) in the set of ROs. For example, the first parameter(s) may include an association period, an association pattern period, an SSB-to-RO mapping cycle, or other parameter(s) associated with the additional ROs. Accordingly, the UE may selectively perform PRACH transmission(s) during the first subset of ROs according to the first parameter(s).

Aspects of the disclosure are initially described in the context of wireless communications systems. Aspects of the disclosure are further illustrated by and described with reference to apparatus diagrams, system diagrams, and flowcharts that relate to association period determination for additional ROs.

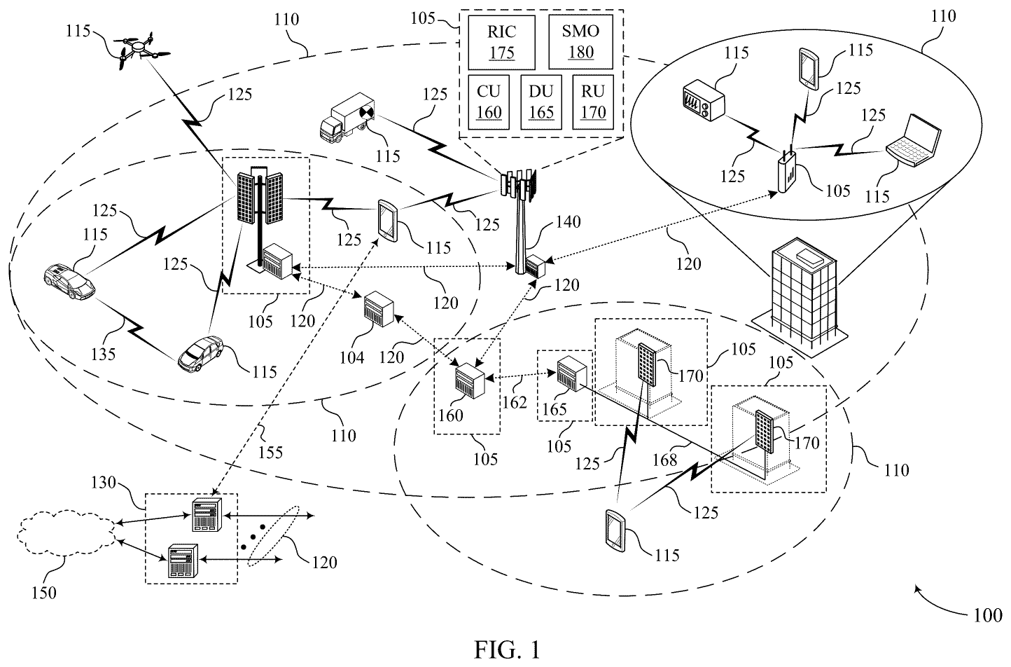

FIG. 1 shows an example of a wireless communications system 100 that supports association period determination for additional ROs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support association period determination for additional ROs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receiving a signal that identifies a configuration for a set of ROs, wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs. The UE 115 may selectively perform one or more PRACH transmissions during the first subset of ROs according to the one or more first parameters.

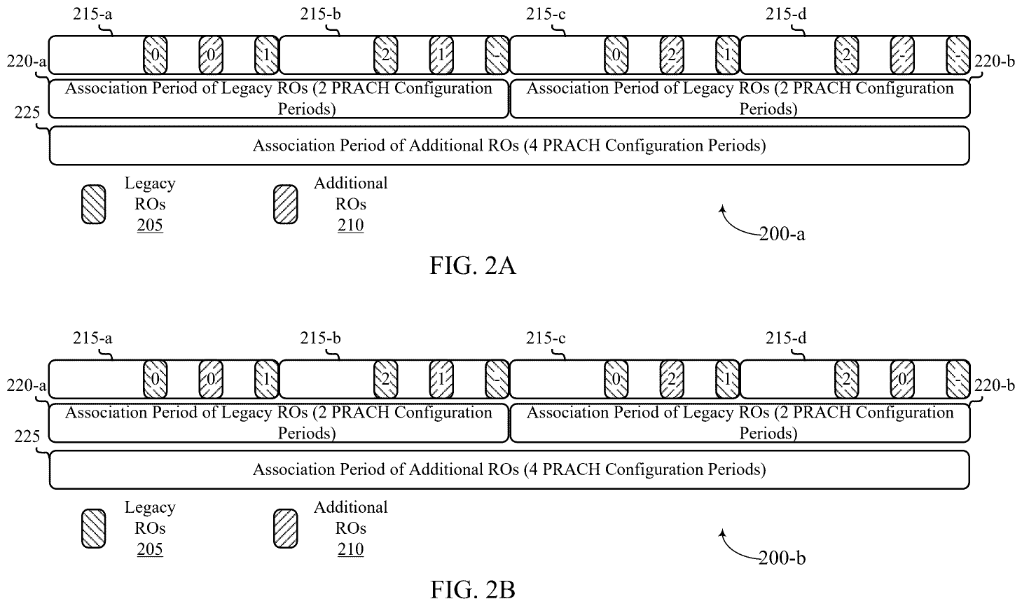

FIGS. 2A and 2B show examples of a RO configuration 200 that supports association period determination for additional ROs in accordance with one or more aspects of the present disclosure. RO configuration 200 may implement aspects of or be implemented by aspects of wireless communications system 100. Aspects of RO configuration 200 may be implemented at or implemented by a UE or a network entity, which may be examples of the corresponding devices described herein.

Wireless networks may provide mechanisms for a UE to establish a wireless connection to the network. For example, the network entity may perform SSB transmissions to a UE within its coverage area. The SSB transmissions include the synchronization signal/physical broadcast channel (SS/PBCH) block that are used by a UE to perform a cell search procedure to acquire time and frequency synchronization with a cell and to detect the physical layer cell identifier (PCI) of the cell. The SSB indicates resources for the UE to receive a system information block (SIB) message, such as the SIB1 message that indicates various parameters for the UE.

One example of such parameters include various RO parameters to be used by the UE for PRACH transmissions during ROs. For example, an association period, starting from frame 0, for mapping the SS/PBCH block indices to ROs may be the smallest value in a set determined by PRACH configuration period according to a (pre) defined or (pre) configured table such that

$${N}_{Tx}^{SSB} ,$$

SS/PBCH block indices are mapped at least once to the PRACH occasions within the association period. The UE may obtain

$${N}_{Tx}^{SSB}$$

from the value of ssu-PositionsInBurst in the SIB1 message or in a ServingCellConfigCommon information element (IE) that is RRC-configured. If after an integer number of SS/PBCH block indices to PRACH occasions mapping cycles within the association period there is a set of PRACH occasions or PRACH preambles that are not mapped to

$${N}_{Tx}^{SSB}$$

SS/PBCH block indices, no SS/PBCH block indices are mapped to the set of PRACH occasions or PRACH preambles. An association pattern period (or association pattern period) may include one or more association periods and may be determined so that a pattern between PRACH occasions and SS/PBCH block indices repeats (e.g., at most every 160 msec). PRACH occasions not associated with SS/PBCH block indices after an integer number of association periods, if any, are not used for PRACH transmission.

For example, the SS/PBCH block indices provided by the ssb-PositionInBurst in the SIB1 or in ServingCellConfigCommon may be mapped to valid PRACH occasions according to an order. The order may include first mapping in increasing order of preamble indices within a single PRACH occasion, second mapping in increasing order of frequency resource indices for frequency multiplexed PRACH occasions, third mapping in increasing order of time resource indices for time multiplex PRACH occasions within a PRACH slot, and fourth mapping in increasing order of indices for PRACH slots. An example of mapping between PRACH configuration period and SS/PBCH block to PRACH occasion association period is shown in Table 1 below.

TABLE 1

| | Association Period |
|---|---|
| PRACH Configuration | (Number of PRACH |
| Period (msec) | Configuration Periods) |
| 10 | {1, 2, 4, 8, 16} |
| 20 | {1, 2, 4, 8} |
| 40 | {1, 2, 4} |
| 80 | {1, 2} |
| 160 | {1} |

The ROs configured according to the discussion above may generally be referred to as legacy ROs that are configured for legacy UE. For example, the legacy ROs (which may be referred to as a second subset of ROs) may be configured for communications according to a TDD configuration where the frequency resources are configured for downlink communications (e.g., downlink frequency resources) during some time periods or for uplink communications (e.g., uplink frequency resources) during other time periods.

However, some UE may be SBFD aware UEs that are capable of or otherwise support wireless communications including random access procedures during SBFD-configured symbols and slots. The SBFD-configured symbols and slots may include the frequency resources being divided into subbands where at least one subband is an uplink subband available for uplink communications and at least one subband is a downlink subband available for downlink communications for symbol(s), slot(s), subframe(s), or other time periods. In some wireless networks, configuring ROs for SBFD aware UE may be use different options. One option may include a single RACH configuration being configured where the ROs within an uplink subband in SBFD symbols can be valid for SBFD-aware UE. Another option may include using two RACH configurations including one legacy RACH configuration and one additional RACH configuration where the ROs within the uplink subband in SBFD symbols are configured by the additional RACH configuration and can be valid for SBFD aware UE.

However, in such networks, the SBFD aware UE may still need to identify or otherwise determine the association period and association pattern period for both the legacy ROs and the additional ROs. For example, the SBFD aware UE may determine the association period and the association pattern period for the legacy ROs using such techniques. However, such UE may need to identify or otherwise determine whether to use the same or different techniques for determination of the association period for the additional ROs.

Accordingly, aspects of the techniques described herein provide various techniques for the UE to identify or otherwise determine the association period or association pattern period while providing the added gains of using the additional ROs. Aspects of the techniques described herein provide a rule that works for the scenarios where the additional ROs are more dense or less dense than the legacy ROs. For example, the techniques described herein provide for determination of the association period of the additional ROs based on both the additional RO density (e.g., the number of additional ROs) with respect to the legacy RO density within the PRACH configuration period.

For example, the UE may receive or otherwise obtain a signal (e.g., SIB1 or RRC signal(s) or message(s)) that identifies a configuration for a set of ROs. The set of ROs may include a first subset of ROs (e.g., the additional ROs 210) and a second subset of ROs (e.g., the legacy ROs 205). In some aspects, first parameter(s) associated with the additional ROs 210 (e.g., the first subset of ROs) may be associated with second parameter(s) associated with the legacy ROs (e.g., the second subset of ROs). For example, in some cases the association period 225 of the additional ROs 210 may be associated, at least in some aspects, with the association period 220 of the legacy ROs 205. The UE may selective perform PRACH transmission(s) during the additional ROs 210 (e.g., during the first subset of ROs) according to the first parameter(s). Accordingly, in some aspects, the SBFD aware UE may identify or otherwise determine the association period 225 of the additional ROs 210 based, it least in some aspects, on the association period 220 of the legacy ROs 205. For example, in some case the association period and the association pattern period of the additional ROs 210 may be determined with respect to the association period and the association pattern period of the legacy ROs 205.

For example, in some cases the UE may be configured (e.g., via a RRC parameter or SIB) with an indication of whether the association period 225 of the additional ROs 210 is determined to be as the same from the association period 220 of the legacy ROs 205 or separate (e.g., an integer number multiplier) based on a configuration obtained from the network entity. For example, the UE may receive or otherwise obtain an indication of at least the association period associated with the first subset of ROs (e.g., the association period 225 of the additional ROs 210) that identifies whether a same association period or different association periods are used for the first subset of ROs and the second subset of ROs (e.g., the legacy ROs 205).

In some cases, whether the association period 225 of the additional ROs 210 is determined as the same as the association period 220 of the legacy ROs 205 or separate is determined based on the ratio of the number of additional ROs 210 to the number of legacy ROs 205 within the PRACH configuration period 215. For example, at least the association period associated with the first subset of ROs may be in accordance with a ratio between a first quantity of additional ROs 210 in the first subset of ROs and a second quantity of legacy ROs 205 in the second subset of ROs.

In some cases, the association period 225 of the additional ROs 210 may be determined as the minimum number of legacy association periods starting from subframe 0 that provides a full SSB-to-RO mapping cycle for the additional ROs 210. For example, at least the association period associated with the first subset of ROs may be in accordance with a minimum quantity associated with the association period 220 of the second subset of ROs that satisfies a mapping cycle threshold (e.g., a mapping cycle, such as the SSB-to-RO mapping cycle).

Accordingly, in some cases the determination of the association period 225 of the additional ROs 210 based on the association period 220 of the legacy ROs 205 may be based on the density of the additional ROs 210 with respect to the density of the legacy ROs 205. RO configuration 200 illustrates an example where the number of additional ROs 210 (or the density of the additional ROs 210) is less than the number of legacy ROs 205 within the legacy association period (e.g., the association period 220) or within the PRACH configuration period 215. That is, in this example the first quantity of additional ROs 210 in the first subset of ROs is less than the second quantity of legacy ROs 205 in the second subset of ROs.

For example, and turning first to RO configuration 200-a of FIG. 2A, the configuration of the set of ROs may include or span four PRACH configuration periods. The PRACH configuration period 215-a may include two of the legacy ROs 205 that are mapped to SSB 0 and 1 and one of the additional ROs 210 that is mapped to SSB 0. The PRACH configuration period 215-b may include two of the legacy ROs 205, where the first is mapped to SSB 2 and the second is not mapped to an SSB (e.g., as indicated by the “-” and may also be referred to as a non-mapped or unmapped RO). The PRACH configuration period 215-b may include one additional ROs 210 that is mapped to SSB 1. The PRACH configuration period 215-c may include two of the legacy ROs 205 that are mapped to SSB 0 and 1 and one of the additional ROs 210 that is mapped to SSB 2. The PRACH configuration period 215-d may include two of the legacy ROs 205, where the first is mapped to SSB 2 and the second is not mapped to an SSB. The PRACH configuration period 215-d may include one of the additional ROs 210 that is also not mapped to an SSB transmission.

In this example, the association period 220 of the legacy ROs 205 includes or otherwise spans two PRACH configuration periods. For example, the association period 220-a may span the PRACH configuration period 215-a and the PRACH configuration period 215-b while the association period 220-b may span the PRACH configuration period 215-c and the PRACH configuration period 215-d. However, the association period 225 for the additional ROs 210 may be determined by the SBFD aware UEs may include or otherwise span four PRACH configuration periods.

In this example the association period between the legacy ROs 205 and the additional ROs 210 are separate but dependent. That is, the association period 225 of the additional ROs 210 may be given by the smallest integer of association period 220 of the legacy ROs 205 such that there is at least one SSB mapping cycle to the additional ROs 210. This may be based on Table 1 above where the association period 225 of the additional ROs 210 may be given by the integer number in Table 1 of the PRACH configuration period. That is, at least the association period associated with the first subset of ROs may be independent from the association period 220 of the legacy ROs 205 in accordance with a smallest integer of the association period 220 of the legacy ROs 205 that satisfies a mapping cycle of ROs that are mapped to SSB transmissions. In this example, the association period 225 of the additional ROs 210 is two of the association period 220 (e.g., an integer number) of the legacy ROs 205.

In some aspects, the RO(s) in the first subset of ROs that occur after the integer number of the mapping cycle may include either non-mapped ROs that are unavailable for PRACH transmissions or mapped ROs that are available for PRACH transmissions according to a partial mapping cycle. RO configuration 200-a of FIG. 2A illustrates an example where the RO(s) in the first subset of ROs occurring after the integer number of the mapping cycle are non-mapped ROs. As shown in FIG. 2A, the additional ROs 210 in the PRACH configuration period 215-d is not mapped to an SSB transmission and is therefore unavailable for PRACH transmissions.

Turning next to RO configuration 200-b of FIG. 2B, the configuration of the set of ROs may include or span four PRACH configuration periods. The PRACH configuration period 215-a may include two of the legacy ROs 205 that are mapped to SSB 0 and 1 and one of the additional ROs 210 that is mapped to SSB 0. The PRACH configuration period 215-b may include two of the legacy ROs 205, where the first is mapped to SSB 2 and the second is not mapped to an SSB (e.g., as indicated by the “-” and may also be referred to as a non-mapped or unmapped RO). The PRACH configuration period 215-b may include one additional ROs 210 that is mapped to SSB 1. The PRACH configuration period 215-c may include two of the legacy ROs 205 that are mapped to SSB 0 and 1 and one of the additional ROs 210 that is mapped to SSB 2. The PRACH configuration period 215-d may include two of the legacy ROs 205, where the first is mapped to SSB 2 and the second is not mapped to an SSB. The PRACH configuration period 215-d may include one of the additional ROs 210 that is mapped to SSB 0.

In this example, the association period 220 of the legacy ROs 205 includes or otherwise spans two PRACH configuration periods. For example, the association period 220-a may span the PRACH configuration period 215-a and the PRACH configuration period 215-b while the association period 220-b may span the PRACH configuration period 215-c and the PRACH configuration period 215-d. However, the association period 225 for the additional ROs 210 may be determined by the SBFD aware UEs may include or otherwise span four PRACH configuration periods.

In this example the association period between the legacy ROs 205 and the additional ROs 210 are separate but dependent. That is, the association period 225 of the additional ROs 210 may be given by the smallest integer of association period 220 of the legacy ROs 205 such that there is at least one SSB mapping cycle to the additional ROs 210. This may be based on Table 1 above where the association period 225 of the additional ROs 210 may be given by the integer number in Table 1 of the PRACH configuration period. That is, at least the association period associated with the first subset of ROs may be independent from the association period 220 of the legacy ROs 205 in accordance with a smallest integer of the association period 220 of the legacy ROs 205 that satisfies a mapping cycle of ROs that are mapped to SSB transmissions. In this example, the association period 225 of the additional ROs 210 is two of the association period 220 (e.g., an integer number) of the legacy ROs 205.

In some aspects, the RO(s) in the first subset of ROs that occur after the integer number of the mapping cycle may include either non-mapped ROs that are unavailable for PRACH transmissions or mapped ROs that are available for PRACH transmissions according to a partial mapping cycle. RO configuration 200-b of FIG. 2B illustrates an example where the RO(s) in the first subset of ROs occurring after the integer number of the mapping cycle are mapped ROs. As shown in FIG. 2B, the additional ROs 210 in the PRACH configuration period 215-d is mapped to SSB 0 and is therefore available for PRACH transmissions. In the next association period of the additional RO, either the mapping start with the first SSB in the set of SSB given by SSBPositionInBurst, or continue the mapping based on the last SSB index mapped in the previous association period (e.g., start the mapping with SSB1 as SSB0 is last mapped in the previous association period)

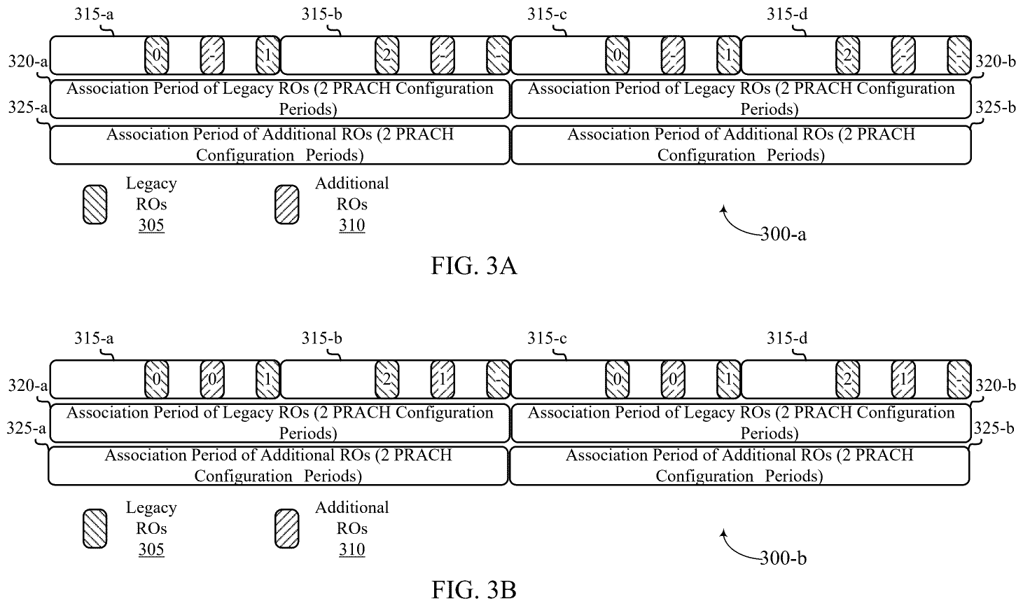

FIGS. 3A and 3B show examples of a RO configuration 300 that supports association period determination for additional ROs in accordance with one or more aspects of the present disclosure. RO configuration 300 may implement aspects of or be implemented by aspects of wireless communications system 100. Aspects of RO configuration 300 may be implemented at or implemented by a UE or a network entity, which may be examples of the corresponding devices described herein.

Aspects of the techniques described herein provide various techniques for the UE to identify or otherwise determine the association period or association pattern period while providing the added gains of using the additional ROs. Aspects of the techniques described herein provide a rule that works for the scenarios where the additional ROs are more dense or less dense than the legacy ROs. For example, the techniques described herein provide for determination of the association period of the additional ROs based on both the additional RO density (e.g., the number of additional ROs) with respect to the legacy RO density within the PRACH configuration period.

For example, the UE may receive or otherwise obtain a signal (e.g., SIB1 or RRC signal(s) or message(s)) that identifies a configuration for a set of ROs. The set of ROs may include a first subset of ROs (e.g., the additional ROs 310) and a second subset of ROs (e.g., the legacy ROs 305). In some aspects, first parameter(s) associated with the additional ROs 310 (e.g., the first subset of ROs) may be associated with second parameter(s) associated with the legacy ROs 305 (e.g., the second subset of ROs). For example, in some cases the association period 325 of the additional ROs 310 may be associated, at least in some aspects, with the association period 320 of the legacy ROs 305. The UE may selective perform PRACH transmission(s) during the additional ROs 310 (e.g., during the first subset of ROs) according to the first parameter(s). Accordingly, in some aspects, the SBFD aware UE may identify or otherwise determine the association period 325 of the additional ROs 310 based, it least in some aspects, on the association period 320 of the legacy ROs 305. For example, in some case the association period and the association pattern period of the additional ROs 310 may be determined with respect to the association period and the association pattern period of the legacy ROs 305.

For example, in some cases the UE may be configured with an indication of whether the association period 325 of the additional ROs 310 is determined to be as the same from the association period 320 of the legacy ROs 305 or separate (e.g., an integer number multiplier) based on a configuration obtained from the network entity. For example, the UE may receive or otherwise obtain an indication of at least the association period associated with the first subset of ROs (e.g., the association period 325 of the additional ROs 310) that identifies whether a same association period or different association periods are used for the first subset of ROs and the second subset of ROs (e.g., the legacy ROs 305).

In some cases, whether the association period 325 of the additional ROs 310 is determined as the same as the association period 320 of the legacy ROs 305 or separate is determined based on the ratio of the number of additional ROs 310 to the number of legacy ROs 305 within the PRACH configuration period 315. For example, at least the association period associated with the first subset of ROs may be in accordance with a ratio between a first quantity of additional ROs 310 in the first subset of ROs and a second quantity of legacy ROs 305 in the second subset of ROs.

In some cases, the association period 325 of the additional ROs 310 may be determined as the minimum number of legacy association periods starting from subframe 0 that provides a full SSB-to-RO mapping cycle for the additional ROs 310. For example, at least the association period associated with the first subset of ROs may be in accordance with a minimum quantity associated with the association period 320 of the second subset of ROs that satisfies a mapping cycle threshold (e.g., a mapping cycle, such as the SSB-to-RO mapping cycle).

Accordingly, in some cases the determination of the association period 325 of the additional ROs 310 is based on the association period 320 of the legacy ROs 305 may be based on the density of the additional ROs 310 with respect to the density of the legacy ROs 305. RO configuration 300 illustrates an example where the number of additional ROs 310 (or the density of the additional ROs 310) is less than the number of legacy ROs 305 within the legacy association period (e.g., the association period 320) or within the PRACH configuration period 315. That is, in this example the first quantity of additional ROs 310 in the first subset of ROs is less than the second quantity of legacy ROs 305 in the second subset of ROs.

For example, and turning first to RO configuration 300-a of FIG. 3A, the configuration of the set of ROs may include or span four PRACH configuration periods. The PRACH configuration period 315-a may include two of the legacy ROs 305 that are mapped to SSB 0 and 1 and one of the additional ROs 310 that is not mapped to an SSB. The PRACH configuration period 315-b may include two of the legacy ROs 305, where the first is mapped to SSB 2 and the second is not mapped to an SSB (e.g., as indicated by the “-” and may also be referred to as a non-mapped or unmapped RO). The PRACH configuration period 315-b may include one additional ROs 310 that is not mapped to an SSB. The PRACH configuration period 315-c may include two of the legacy ROs 305 that are mapped to SSB 0 and 1 and one of the additional ROs 310 that is not mapped to an SSB. The PRACH configuration period 315-d may include two of the legacy ROs 305, where the first is mapped to SSB 2 and the second is not mapped to an SSB. The PRACH configuration period 315-d may include one of the additional ROs 310 that is also not mapped to an SSB transmission.

In this example, the association period 320 of the legacy ROs 305 includes or otherwise spans two PRACH configuration periods. For example, the association period 320-a may span the PRACH configuration period 315-a and the PRACH configuration period 315-b while the association period 320-b may span the PRACH configuration period 315-c and the PRACH configuration period 315-d. In this example, the association period 325 for the additional ROs 310 may be determined by the SBFD aware UEs may be the same as the association period 320 of the legacy ROs 305 (e.g., may also include or otherwise span two PRACH configuration periods). For example, the association period 325-a of the additional ROs 310 may span the PRACH configuration period 315-a and the PRACH configuration period 315-b while the association period 325-b of the additional ROs 310 may span the PRACH configuration period 315-c and the PRACH configuration period 315-d. In this example the association period between the legacy ROs 305 and the additional ROs 310 are the same. That is, the association period 325 of the additional ROs 310 may be given by association period 320 of the legacy ROs 305.

In some aspects, when there is not enough ROs for one complete SSB mapping cycle (e.g., the SSB-to-RO mapping cycle), the additional ROs are not used and are not mapped to SSBs. For example, a first quantity of ROs in the first subset of ROs that fail to satisfy the mapping cycle may be non-mapped ROs that are unavailable for PRACH transmissions. That is, these non-mapped ROs that are unavailable for PRACH transmissions may be based on that quantity of ROs failing to satisfy the mapping cycle. As discussed above, the mapping cycle may result in the first quantity of ROs being non-mapped to SSB transmissions. As shown in FIG. 3A, this may include the additional ROs 310 in each PRACH configuration period 315 not being mapped to SSB transmissions, and therefore being unavailable for PRACH transmissions.

In some aspects, the RO(s) in the first subset of ROs that occur after the integer number of the mapping cycle may include either non-mapped ROs that are unavailable for PRACH transmissions or mapped ROs that are available for PRACH transmissions according to a partial mapping cycle. RO configuration 200-a of FIG. 2A illustrates an example where the RO(s) in the first subset of ROs occurring after the integer number of the mapping cycle are non-mapped ROs. As shown in FIG. 2A, the additional ROs 210 in the PRACH configuration period 215-d is not mapped to an SSB transmission and is therefore unavailable for PRACH transmissions.

Turning next to RO configuration 300-b of FIG. 3B, the configuration of the set of ROs may include or span four PRACH configuration periods. The PRACH configuration period 315-a may include two of the legacy ROs 305 that are mapped to SSB 0 and 1 and one of the additional ROs 210 that is mapped to SSB 0. The PRACH configuration period 315-b may include two of the legacy ROs 305, where the first is mapped to SSB 2 and the second is not mapped to an SSB. The PRACH configuration period 315-b may include one additional ROs 310 that is mapped to SSB 1. The PRACH configuration period 315-c may include two of the legacy ROs 305 that are mapped to SSB 0 and 1 and one of the additional ROs 310 that is mapped to SSB 0. The PRACH configuration period 315-d may include two of the legacy ROs 305, where the first is mapped to SSB 2 and the second is not mapped to an SSB. The PRACH configuration period 315-d may include one of the additional ROs 310 that is mapped to SSB 1.

In this example, the association period 320 of the legacy ROs 305 includes or otherwise spans two PRACH configuration periods. For example, the association period 320-a may span the PRACH configuration period 315-a and the PRACH configuration period 315-b while the association period 320-b may span the PRACH configuration period 315-c and the PRACH configuration period 315-d. In this example, the association period 325 for the additional ROs 310 may be determined by the SBFD aware UEs may be the same as the association period 320 of the legacy ROs 305 (e.g., may also include or otherwise span two PRACH configuration periods). For example, the association period 325-a of the additional ROs 310 may span the PRACH configuration period 315-a and the PRACH configuration period 315-b while the association period 325-b of the additional ROs 310 may span the PRACH configuration period 315-c and the PRACH configuration period 315-d. In this example the association period between the legacy ROs 305 and the additional ROs 310 are the same. That is, the association period 325 of the additional ROs 310 may be given by association period 320 of the legacy ROs 305.

In some aspects, a partial SSB mapping cycle may be applied to the additional ROs 310 within the association period. For the next association period, this may include starting with the first SSB in the sets of the SSBs given by the SSBPositionInBurst parameters. Accordingly, the first quantity of ROs in the first subset of ROs failing to satisfy a mapping cycle threshold may include mapped ROs (e.g., mapped to SSB transmissions) that are available for PRACH transmissions according to the partial mapping cycle. As shown in FIG. 3B, this may include the additional ROs 310 in each PRACH configuration period 315 being mapped to SSB transmissions, and therefore being available for PRACH transmissions.

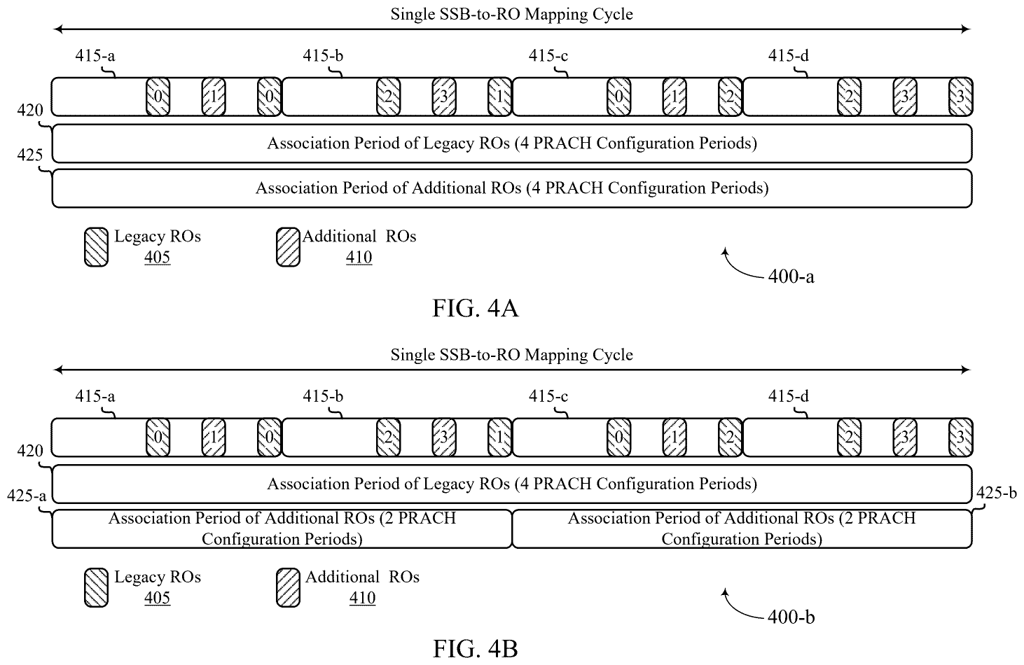

FIGS. 4A and 4B show examples of a RO configuration 400 that supports association period determination for additional ROs in accordance with one or more aspects of the present disclosure. RO configuration 400 may implement aspects of or be implemented by aspects of wireless communications system 100. Aspects of RO configuration 400 may be implemented at or implemented by a UE or a network entity, which may be examples of the corresponding devices described herein.

Aspects of the techniques described herein provide various techniques for the UE to identify or otherwise determine the association period or association pattern period while providing the added gains of using the additional ROs. Aspects of the techniques described herein provide a rule that works for the scenarios where the additional ROs are more dense or less dense than the legacy ROs. For example, the techniques described herein provide for determination of the association period of the additional ROs based on both the additional RO density (e.g., the number of additional ROs) with respect to the legacy RO density within the PRACH configuration period.

For example, the UE may receive or otherwise obtain a signal (e.g., SIB1 or RRC signal(s) or message(s)) that identifies a configuration for a set of ROs. The set of ROs may include a first subset of ROs (e.g., the additional ROs 410) and a second subset of ROs (e.g., the legacy ROs 405). In some aspects, first parameter(s) associated with the additional ROs 410 (e.g., the first subset of ROs) may be associated with second parameter(s) associated with the legacy ROs 405 (e.g., the second subset of ROs). For example, in some cases the association period 425 of the additional ROs 410 may be associated, at least in some aspects, with the association period 420 of the legacy ROs 405. The UE may selective perform PRACH transmission(s) during the additional ROs 410 (e.g., during the first subset of ROs) according to the first parameter(s). Accordingly, in some aspects the SBFD aware UE may identify or otherwise determine the association period 425 of the additional ROs 410 based, it least in some aspects, on the association period 420 of the legacy ROs 405. For example, in some case the association period and the association pattern period of the additional ROs 410 may be determined with respect to the association period and the association pattern period of the legacy ROs 405.

For example, in some cases the UE may be configured with an indication of whether the association period 425 of the additional ROs 410 is determined to be as the same from the association period 420 of the legacy ROs 405 or separate (e.g., an integer number multiplier) based on a configuration obtained from the network entity. For example, the UE may receive or otherwise obtain an indication of at least the association period associated with the first subset of ROs (e.g., the association period 425 of the additional ROs 410) that identifies whether a same association period or different association periods are used for the first subset of ROs and the second subset of ROs (e.g., the legacy ROs 405).

In some cases, whether the association period 425 of the additional ROs 410 is determined as the same as the association period 420 of the legacy ROs 405 or separate is determined based on the ratio of the number of additional ROs 410 to the number of legacy ROs 405 within the PRACH configuration period 415. For example, at least the association period associated with the first subset of ROs may be in accordance with a ratio between a first quantity of additional ROs 410 in the first subset of ROs and a second quantity of legacy ROs 405 in the second subset of ROs.

In some cases, the association period 425 of the additional ROs 410 may be determined as the minimum number of legacy association periods starting from subframe 0 that provides a full SSB-to-RO mapping cycle for the additional ROs 410. For example, at least the association period associated with the first subset of ROs may be in accordance with a minimum quantity associated with the association period 420 of the second subset of ROs that satisfies a mapping cycle threshold (e.g., a mapping cycle, such as the SSB-to-RO mapping cycle).

Accordingly, in some cases the determination of the association period 425 of the additional ROs 410 is based on the association period 420 of the legacy ROs 405 may be based on the density of the additional ROs 410 with respect to the density of the legacy ROs 405. RO configuration 400 illustrates an example where the number of additional ROs 410 (or the density of the additional ROs 410) is more than the number of legacy ROs 405 within the legacy association period (e.g., the association period 420) or within the PRACH configuration period 415. That is, in this example the first quantity of additional ROs 410 in the first subset of ROs is more than the second quantity of legacy ROs 405 in the second subset of ROs.

For example, and turning first to RO configuration 400-a of FIG. 4A, the configuration of the set of ROs may include or span four PRACH configuration periods. The PRACH configuration period 415-a may include two of the legacy ROs 405 that are mapped to SSB 0 and one of the additional ROs 410 that is mapped to SSB 1. The PRACH configuration period 415-b may include two of the legacy ROs 405 that are mapped to SSB 2 and 1 and one additional ROs 410 that is mapped to SSB 3. The PRACH configuration period 415-c may include two of the legacy ROs 405 that are mapped to SSB 0 and 2 and one of the additional ROs 410 that is mapped to SSB 1. The PRACH configuration period 415-d may include two of the legacy ROs 405 that are mapped to SSB 2 and 3 and one of the additional ROs 410 that is mapped to SSB 3.

In this example, the association period 420 of the legacy ROs 405 includes or otherwise spans four PRACH configuration periods. For example, the association period 420 may span the PRACH configuration period 415-a, the PRACH configuration period 415-b, the PRACH configuration period 415-c, and the PRACH configuration period 415-d. In this example, the association period 425 for the additional ROs 410 may be determined by the SBFD aware UEs may be the same as the association period 420 of the legacy ROs 405 (e.g., may also include or otherwise span four PRACH configuration periods). For example, the association period 425 of the additional ROs 410 may span the PRACH configuration period 415-a, the PRACH configuration period 415-b, the PRACH configuration period 415-c, and the PRACH configuration period 415-d. In this example the association period between the legacy ROs 405 and the additional ROs 410 are the same. That is, the association period 425 of the additional ROs 410 may be given by association period 420 of the legacy ROs 405. Accordingly, in this example the number of SSB mapping cycles to the additional RO cycles is more than the number of mapping cycles to the legacy RO cycles.

Turning next to RO configuration 400-b of FIG. 4B, the configuration of the set of ROs may include or span four PRACH configuration periods. The PRACH configuration period 415-a may include two of the legacy ROs 405 that are mapped to SSB 0 and one of the additional ROs 410 that is mapped to SSB 1. The PRACH configuration period 415-b may include two of the legacy ROs 405 that are mapped to SSB 2 and 1 and one additional ROs 410 that is mapped to SSB 3. The PRACH configuration period 415-c may include two of the legacy ROs 405 that are mapped to SSB 0 and 2 and one of the additional ROs 410 that is mapped to SSB 1. The PRACH configuration period 415-d may include two of the legacy ROs 405 that are mapped to SSB 2 and 3 and one of the additional ROs 410 that is mapped to SSB 3.

In this example, the association period 420 of the legacy ROs 405 includes or otherwise spans four PRACH configuration periods. For example, the association period 420 may span the PRACH configuration period 415-a, the PRACH configuration period 415-b, the PRACH configuration period 415-c, and the PRACH configuration period 415-d. In this example, the association period 425 for the additional ROs 410 may be determined by the SBFD aware UEs may be different than the association period 420 of the legacy ROs 405 (e.g., the association period 425 may span two PRACH configuration periods). For example, the association period 425-a of the additional ROs 410 may span the PRACH configuration period 415-a and the PRACH configuration period 415-b while the association period 425-b of the additional ROs 410 may span the PRACH configuration period 415-c and the PRACH configuration period 415-d.

In this example the association period between the legacy ROs 405 and the additional ROs 410 are different. That is, the association period 425 of the additional ROs 410 may be given by an integer value associated with the association period 420 of the legacy ROs 405. For example, the association period 425 of the additional ROs 410 may equal the association period 420 of the legacy ROs divided by the integer value n where n in the integer value. As such, the set of SSBs may be mapped once the additional ROs 410 are within the association period 425. In some aspects, this may be based on Table 1 above for the integer value multiple or divisor for the association period determinations with respect to the PRACH configuration periodicity. Additionally, or alternatively, this may include relaxing the restriction that the association period 425 of the additional ROs 410 be a fractional of the PRACH configuration periodicity (e.g., 0.5) or other integer (e.g., 3 or 5) of the PRACH configuration period.

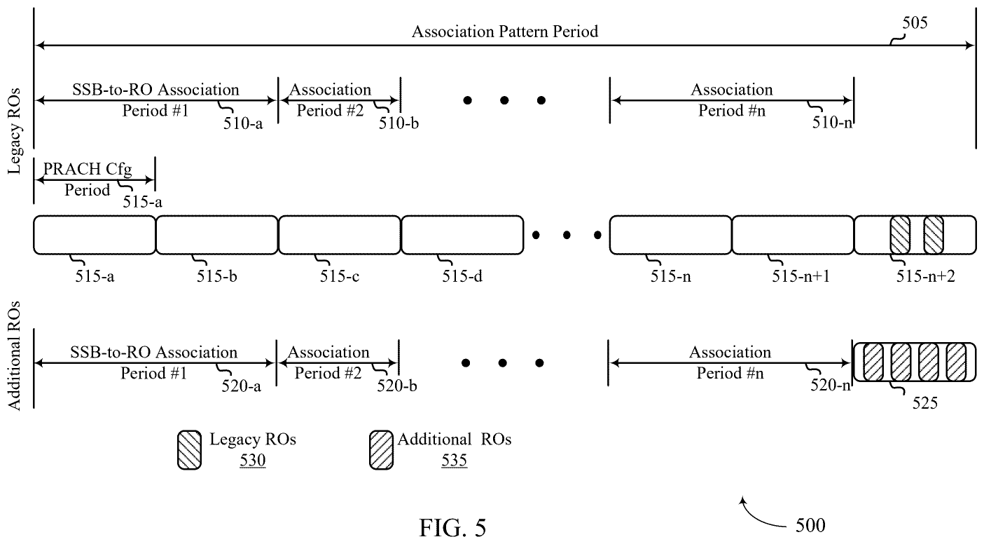

FIG. 5 shows an example of a RO configuration 500 that supports association period determination for additional ROs in accordance with one or more aspects of the present disclosure. RO configuration 500 may implement aspects of or be implemented by aspects of wireless communications system 100. Aspects of RO configuration 500 may be implemented at or implemented by a UE or a network entity, which may be examples of the corresponding devices described herein.

Aspects of the techniques described herein provide various techniques for the UE to identify or otherwise determine the association period or association pattern period while providing the added gains of using the additional ROs 535. Aspects of the techniques described herein provide a rule that works for the scenarios where the additional ROs 535 are more dense or less dense than the legacy ROs 530. For example, the techniques described herein provide for determination of the association period of the additional ROs 535 based on both the additional RO density (e.g., the number of additional ROs 535) with respect to the legacy RO density within the PRACH configuration period.

For example, the UE may receive or otherwise obtain a signal (e.g., SIB1 or RRC signal(s) or message(s)) that identifies a configuration for a set of ROs. The set of ROs may include a first subset of ROs (e.g., the additional ROs 535) and a second subset of ROs (e.g., the legacy ROs 530). In some aspects, first parameter(s) associated with the additional ROs 535 (e.g., the first subset of ROs) may be associated with second parameter(s) associated with the legacy ROs 530 (e.g., the second subset of ROs). For example, in some cases the association period 520 of the additional ROs 535 may be associated, at least in some aspects, with the association period 510 of the legacy ROs 530. The UE may selective perform PRACH transmission(s) during the additional ROs 535 (e.g., during the first subset of ROs) according to the first parameter(s). Accordingly, in some aspects the SBFD aware UE may identify or otherwise determine the association period 520 of the additional ROs 535 based, it least in some aspects, on the association period 510 of the legacy ROs 530. For example, in some case the association period and the association pattern period of the additional ROs 535 may be determined with respect to the association period and the association pattern period of the legacy ROs 530.

RO configuration 500 illustrates aspects of treatment of the remaining ROs that are within an association pattern period 505 (e.g., but outside of the association period 520). For example, the configuration for the set of ROs may define the legacy ROs 530 within the association pattern period 505 that include n association periods as well as at least some period of time after the association period 510-n. For example, the configuration for the legacy ROs 530 may include an association period 510-a, an association period 510-b, and so forth until an association period 510-n. As shown in FIG. 5, the association periods of the legacy ROs 530 may have different durations. For example, the association period 510-a may span two PRACH configuration periods (e.g., PRACH configuration period 515-a and PRACH configuration period 515-b). However, the association period 510-b may span one PRACH configuration period (e.g., the PRACH configuration period 515-c). The PRACH configuration periods may continue with PRACH configuration period 515-d and so forth until PRACH configuration period 515-n and PRACH configuration period 515-n+1 that correspond to the association period 510-n of the legacy ROs 530. The PRACH occasions within the PRACH configuration period 515-n+2, however, may not correspond to an association period. As shown in FIG. 5, the two legacy ROs 530 during the PRACH configuration period 515-n+2 are not mapped to or otherwise associated with SSBs (e.g., due to an insufficient number of ROs being left) and are therefore not available for PRACH transmissions.

In this example, the association period 520 of the additional ROs 535 is the same as the association period 510 of the legacy ROs 530. For example, the association period 520-a of the additional ROs 535 may be the same as the association period 510-a of the legacy ROs 530 (e.g., both span two PRACH configuration periods). The association period 520-b of the additional ROs 535 may be the same as the association period 510-b of the legacy ROs 530 (e.g., both may span one PRACH configuration period). Similarly, the association period 520-n of the additional ROs 535 may be the same as the association period 510-n of the legacy ROs 530. That is, the four additional ROs in the time period 525 may correspond to a third subset of ROs within the first subset of ROs that occur after an integer number of association periods associated with the first subset of ROs.

However, the time period 525 for the additional ROs 535 may include additional ROs that may or may not be valid ROs. For example, in some cases the third subset of ROs are not mapped to SSB transmissions and are not available for PRACH transmissions. In other cases, the third subset of ROs are available for PRACH transmissions in accordance with the first subset of ROs satisfying a mapping cycle threshold. For example, the four additional ROs 535 during the time period 525 may be valid ROs and used for PRACH transmissions if there is one complete SSB-to-RO mapping cycle (e.g., based on the number of additional ROs).

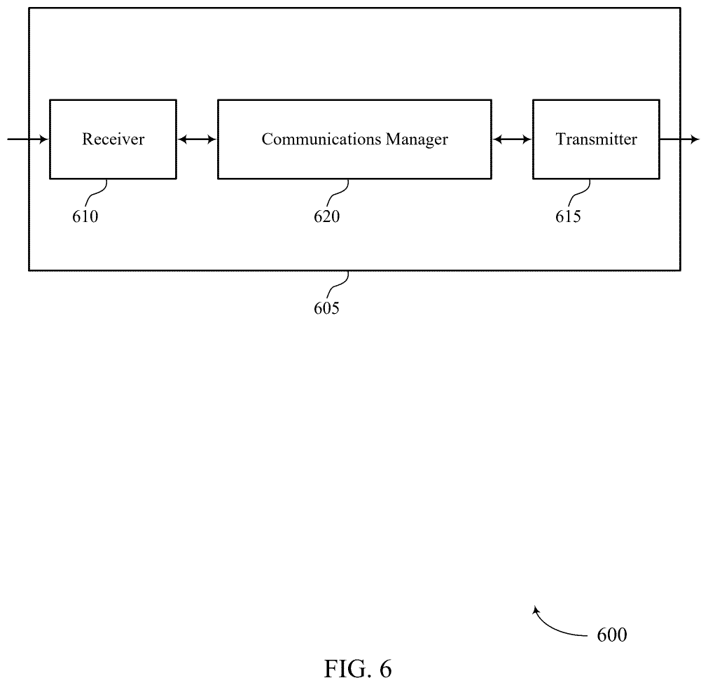

FIG. 6 shows a block diagram 600 of a device 605 that supports association period determination for additional ROs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to association period determination for additional ROs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to association period determination for additional ROs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of association period determination for additional ROs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs. The communications manager 620 is capable of, configured to, or operable to support a means for selectively performing one or more PRACH transmissions during the first subset of ROs according to the one or more first parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for RO parameter(s) determination by both legacy UE and SBFD aware UE using either signaling option (e.g., a single RO configuration or separate RO configurations). The described techniques generally use the parameter(s) of the legacy ROs to identify or otherwise determine the parameter(s) of the additional ROs (e.g., such as the association period parameters).

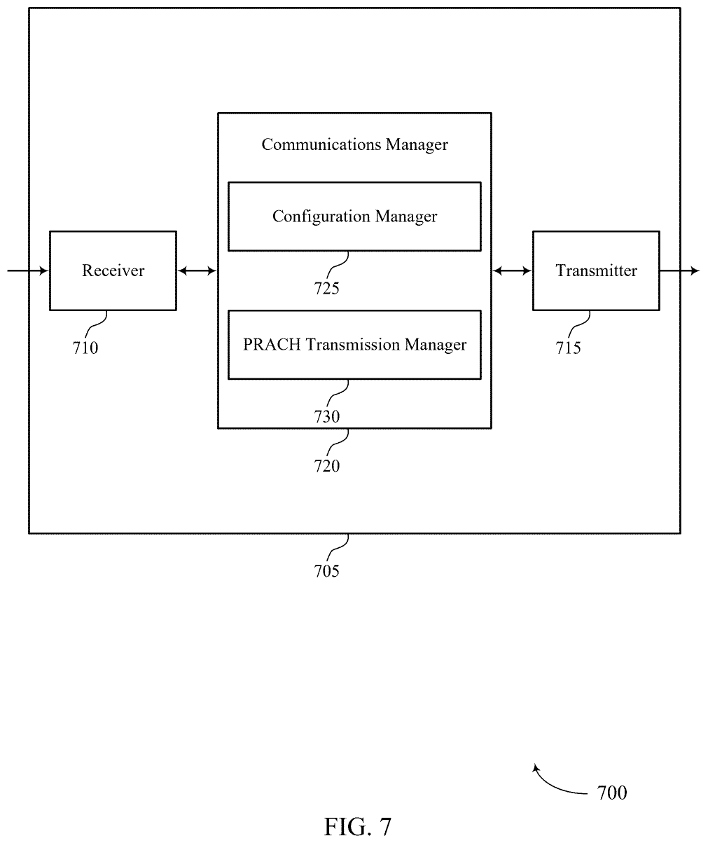

FIG. 7 shows a block diagram 700 of a device 705 that supports association period determination for additional ROs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to association period determination for additional ROs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to association period determination for additional ROs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of association period determination for additional ROs as described herein. For example, the communications manager 720 may include a configuration manager 725 a PRACH transmission manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration manager 725 is capable of, configured to, or operable to support a means for receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs. The PRACH transmission manager 730 is capable of, configured to, or operable to support a means for selectively performing one or more PRACH transmissions during the first subset of ROs according to the one or more first parameters.

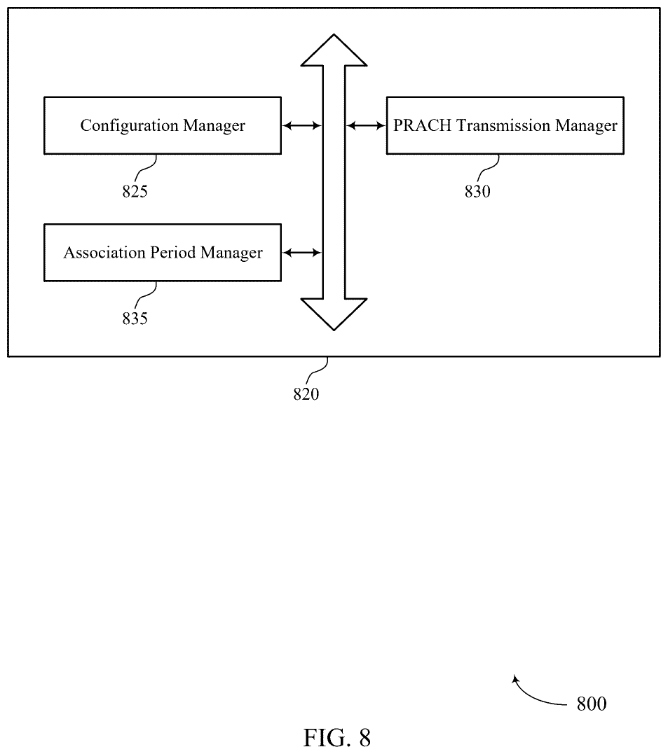

FIG. 8 shows a block diagram 800 of a communications manager 820 that supports association period determination for additional ROs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of association period determination for additional ROs as described herein. For example, the communications manager 820 may include a configuration manager 825, a PRACH transmission manager 830, an association period manager 835, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration manager 825 is capable of, configured to, or operable to support a means for receiving a signal that identifies a configuration for a set of ROs, where one or more first parameters associated with a first subset of ROs in the set of ROs are in accordance with one or more second parameters associated with a second subset of ROs in the set of ROS, where the first subset of ROs include additional ROs and the one or more first parameters include at least an association period associated with the first subset of ROs. The PRACH transmission manager 830 is capable of, configured to, or operable to support a means for selectively performing one or more PRACH transmissions during the first subset of ROs according to the one or more first parameters.

In some examples, at least one RO of the additional Ros includes at least one SBFD symbol. In some examples, a first quantity of additional ROs in the first subset of ROs is less than a second quantity of ROs in the second subset of ROs. In some examples, at least the association period associated with the first subset of ROs is independent from a second subset of ROs association period and in accordance with a smallest integer of the second subset of ROs association period that satisfies a mapping cycle of ROs that are mapped to SSB transmissions. In some examples, one or more ROs in the first subset of ROs that occur after an integer number of the mapping cycle include either non-mapped ROs that are unavailable for PRACH transmissions or mapped ROs that are available for PRACH transmissions according to a partial mapping cycle. In some examples, at least the association period associated with the first subset of ROs is a same association period as a second subset of ROs association period.

In some examples, a first quantity of ROs in the first subset of ROs fails to satisfy a mapping cycle and the first subset of ROs include non-mapped ROs that are unavailable for PRACH transmission in accordance with the first quantity of ROs failing to satisfy the mapping cycle, and the mapping cycle corresponds to ROs that are non-mapped to SSB transmissions. In some examples, a first quantity of ROs in the first subset of ROs fails to satisfy a mapping cycle threshold and the first subset of ROs include mapped ROs that are available for PRACH transmission in accordance with a partial mapping cycle. In some examples, a first quantity of additional ROs in the first subset of ROs is more than a second quantity of ROs in the second subset of ROs. In some examples, at least the association period associated with the first subset of ROs is a same association period as a second subset of ROs association period. In some examples, at least the association period associated with the first subset of ROs is in accordance with an integer value associated with a second subset of ROs association period.

In some examples, the association period manager 835 is capable of, configured to, or operable to support a means for receiving an indication of at least the association period associated with the first subset of ROs, where the indication identifies whether a same association period or different association periods are used for the first subset of ROs and the second subset of ROs. In some examples, at least the association period associated with the first subset of ROs is in accordance with a ratio between a first quantity of additional ROs in the first subset of ROs and a second quantity of ROs in the second subset of ROs. In some examples, at least the association period associated with the first subset of ROs is in accordance with a minimum quantity associated with a second subset of ROs association period that satisfies a mapping cycle threshold. In some examples, a third subset of ROs within the first subset of ROs occur after an integer number of association periods associated with the first subset of ROs.

In some examples, ROs in the third subset of ROs are not non-mapped to SSB transmissions and are not available for PRACH transmissions. In some examples, ROs in the third subset of ROs are available for PRACH transmissions in accordance with the first subset of ROs satisfying a mapping cycle threshold.

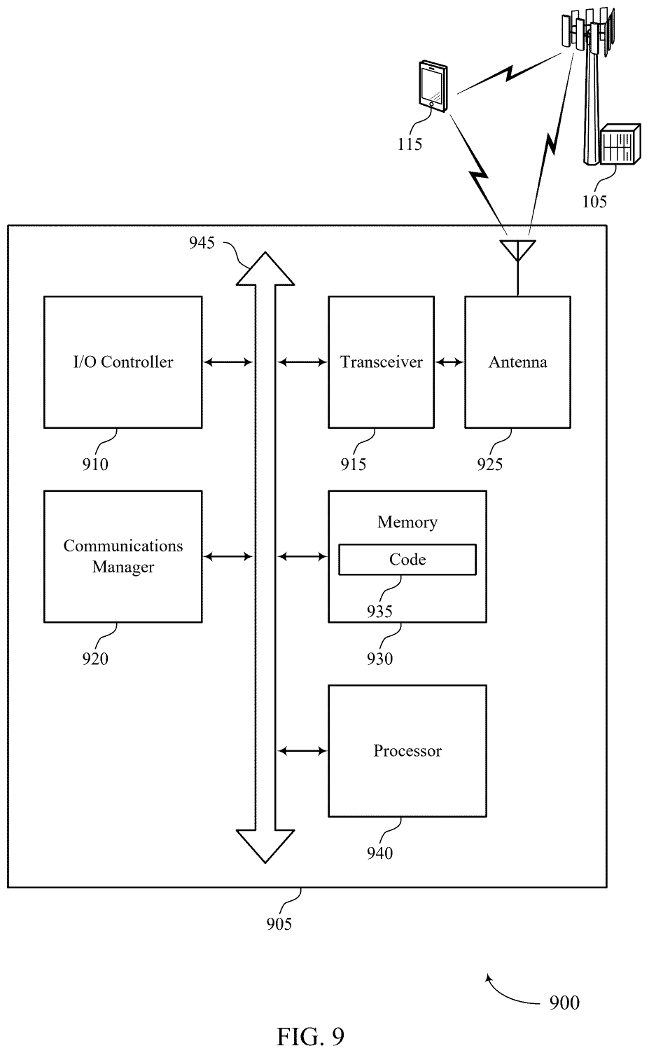

FIG. 9 shows a diagram of a system 900 including a device 905 that supports association period determination for additional ROs in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting association period determination for additional ROs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs. The communications manager 920 is capable of, configured to, or operable to support a means for selectively performing one or more PRACH transmissions during the first subset of ROs according to the one or more first parameters.

By including or configuring the communications manager 920 in accordance with examples as described herein, the device 905 may support techniques for RO parameter(s) determination by both legacy UE and SBFD aware UE using either signaling option (e.g., a single RO configuration or separate RO configurations). The described techniques generally use the parameter(s) of the legacy ROs to identify or otherwise determine the parameter(s) of the additional ROs (e.g., such as the association period parameters).

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of association period determination for additional ROs as described herein, or the at least one processor 940 and the at least one memory 930 may be otherwise configured to, individually or collectively, perform or support such operations.

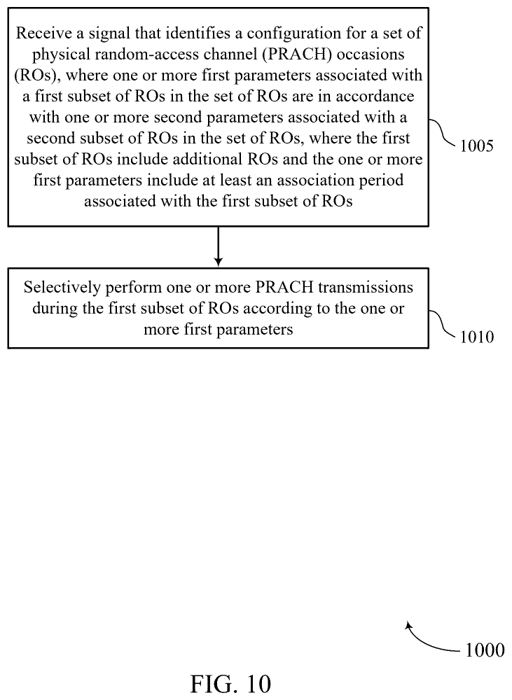

FIG. 10 shows a flowchart illustrating a method 1000 that supports association period determination for additional ROs in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs. The operations of 1005 may be performed in accordance with examples as disclosed herein. In some examples, aspects of the operations of 1005 may be performed by a configuration manager 825 as described with reference to FIG. 8.

At 1010, the method may include selectively performing one or more PRACH transmissions during the first subset of ROs according to the one or more first parameters. The operations of 1010 may be performed in accordance with examples as disclosed herein. In some examples, aspects of the operations of 1010 may be performed by a PRACH transmission manager 830 as described with reference to FIG. 8.

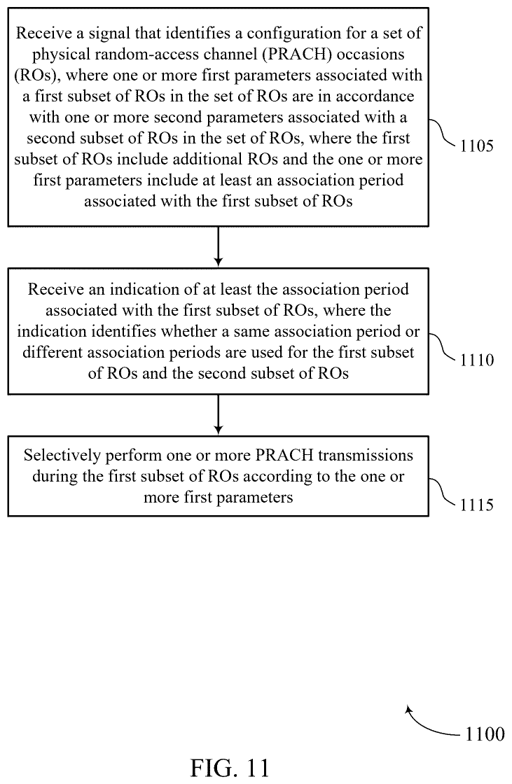

FIG. 11 shows a flowchart illustrating a method 1100 that supports association period determination for additional ROs in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a signal that identifies a configuration for a set of ROs, where one or more first parameters associated with a first subset of ROs in the set of ROs are in accordance with one or more second parameters associated with a second subset of ROs in the set of ROs, where the first subset of ROs include additional ROs and the one or more first parameters include at least an association period associated with the first subset of ROs. The operations of 1105 may be performed in accordance with examples as disclosed herein. In some examples, aspects of the operations of 1105 may be performed by a configuration manager 825 as described with reference to FIG. 8.

At 1110, the method may include receiving an indication of at least the association period associated with the first subset of ROs, where the indication identifies whether a same association period or different association periods are used for the first subset of ROs and the second subset of ROs. The operations of 1110 may be performed in accordance with examples as disclosed herein. In some examples, aspects of the operations of 1110 may be performed by an association period manager 835 as described with reference to FIG. 8.

At 1115, the method may include selectively performing one or more PRACH transmissions during the first subset of ROs according to the one or more first parameters. The operations of 1115 may be performed in accordance with examples as disclosed herein. In some examples, aspects of the operations of 1115 may be performed by a PRACH transmission manager 830 as described with reference to FIG. 8.

The following provides an overview of aspects of the present disclosure:

Aspect 1: A method for wireless communications at a UE, comprising: receiving a signal that identifies a configuration for a set of ROs, wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs; and selectively performing one or more PRACH transmissions during the first subset of ROs according to the one or more first parameters.

Aspect 2: The method of aspect 1, wherein at least one RO of the additional ROs comprises at least one SBFD symbol

Aspect 3: The method of aspect 1, wherein a first quantity of additional ROs in the first subset of ROs is less than a second quantity of ROs in the second subset of ROs.

Aspect 4: The method of aspect 3, wherein at least the association period associated with the first subset of ROs is independent from a second subset of ROs association period and in accordance with a smallest integer of the second subset of ROs association period that satisfies a mapping cycle of ROs that are mapped to SSB transmissions.

Aspect 5: The method of aspect 4, wherein one or more ROs in the first subset of ROs that occur after an integer number of the mapping cycle comprise either non-mapped ROs that are unavailable for PRACH transmissions or mapped ROs that are available for PRACH transmissions according to a partial mapping cycle.

Aspect 6: The method of any of aspects 3 through 5, wherein at least the association period associated with the first subset of ROs is a same association period as a second subset of ROs association period.

Aspect 7: The method of aspect 6, wherein a first quantity of ROs in the first subset of ROs fails to satisfy a mapping cycle and the first subset of ROs comprise non-mapped ROs that are unavailable for PRACH transmission in accordance with the first quantity of ROs failing to satisfy the mapping cycle, and the mapping cycle corresponds to ROs that are non-mapped to SSB transmissions.

Aspect 8: The method of any of aspects 6 through 7, wherein a first quantity of ROs in the first subset of ROs fails to satisfy a mapping cycle threshold and the first subset of ROs comprise mapped ROs that are available for PRACH transmission in accordance with a partial mapping cycle.

Aspect 9: The method of any of aspects 1 through 8, wherein a first quantity of additional ROs in the first subset of ROs is more than a second quantity of ROs in the second subset of ROs.

Aspect 10: The method of aspect 9, wherein at least the association period associated with the first subset of ROs is a same association period as a second subset of ROs association period.

Aspect 11: The method of any of aspects 9 through 10, wherein at least the association period associated with the first subset of ROs is in accordance with an integer value associated with a second subset of ROs association period.

Aspect 12: The method of any of aspects 1 through 11, further comprising: receiving an indication of at least the association period associated with the first subset of ROs, wherein the indication identifies whether a same association period or different association periods are used for the first subset of ROs and the second subset of ROs.

Aspect 13: The method of any of aspects 1 through 12, wherein at least the association period associated with the first subset of ROs is in accordance with a ratio between a first quantity of additional ROs in the first subset of ROs and a second quantity of ROs in the second subset of ROs.

Aspect 14: The method of any of aspects 1 through 13, wherein at least the association period associated with the first subset of ROs is in accordance with a minimum quantity associated with a second subset of ROs association period that satisfies a mapping cycle threshold.

Aspect 15: The method of any of aspects 1 through 14, wherein a third subset of ROs within the first subset of ROs occur after an integer number of association periods associated with the first subset of ROs.

Aspect 16: The method of aspect 15, wherein ROs in the third subset of ROs are not non-mapped to SSB transmissions and are not available for PRACH transmissions.

Aspect 17: The method of any of aspects 15 through 16, wherein ROs in the third subset of ROs are available for PRACH transmissions in accordance with the first subset of ROs satisfying a mapping cycle threshold.

Aspect 18: A UE for wireless communications, comprising one or more memories storing processor-executable code, and one or more processors coupled with the one or more memories and individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a signal that identifies a configuration for a set of physical random-access channel (PRACH) occasions (ROs), wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs; and
selectively perform one or more PRACH transmissions during the first subset of ROs according to the one or more first parameters.

2. The UE of claim 1, wherein at least one RO of the additional ROs comprises at least one sub-band full duplex (SBFD) symbol.

3. The UE of claim 1, wherein a first quantity of additional ROs in the first subset of ROs is less than a second quantity of ROs in the second subset of ROs.

4. The UE of claim 3, wherein at least the association period associated with the first subset of ROs is independent from a second subset of ROs association period and in accordance with a smallest integer of the second subset of ROs association period that satisfies a mapping cycle of ROs that are mapped to synchronization signal block (SSB) transmissions.

5. The UE of claim 4, wherein one or more ROs in the first subset of ROs that occur after an integer number of the mapping cycle comprise either non-mapped ROs that are unavailable for PRACH transmissions or mapped ROs that are available for PRACH transmissions according to a partial mapping cycle.

6. The UE of claim 3, wherein at least the association period associated with the first subset of ROs is a same association period as a second subset of ROs association period.

7. The UE of claim 6, wherein a first quantity of ROs in the first subset of ROs fails to satisfy a mapping cycle and the first subset of ROs comprise non-mapped ROs that are unavailable for PRACH transmission in accordance with the first quantity of ROs failing to satisfy the mapping cycle, and the mapping cycle corresponds to ROs that are non-mapped to synchronization signal block (SSB) transmissions.

8. The UE of claim 6, wherein a first quantity of ROs in the first subset of ROs fails to satisfy a mapping cycle threshold and the first subset of ROs comprise mapped ROs that are available for PRACH transmission in accordance with a partial mapping cycle.

9. The UE of claim 1, wherein a first quantity of additional ROs in the first subset of ROs is more than a second quantity of ROs in the second subset of ROs.

10. The UE of claim 9, wherein at least the association period associated with the first subset of ROs is a same association period as a second subset of ROs association period.

11. The UE of claim 9, wherein at least the association period associated with the first subset of ROs is in accordance with an integer value associated with a second subset of ROs association period.

12. The UE of claim 1, wherein the one or more processors are individually or collectively further operable to execute the code to cause the UE to:
receive an indication of at least the association period associated with the first subset of ROs, wherein the indication identifies whether a same association period or different association periods are used for the first subset of ROs and the second subset of ROs.

13. The UE of claim 1, wherein at least the association period associated with the first subset of ROs is in accordance with a ratio between a first quantity of additional ROs in the first subset of ROs and a second quantity of ROs in the second subset of ROs.

14. The UE of claim 1, wherein at least the association period associated with the first subset of ROs is in accordance with a minimum quantity associated with a second subset of ROs association period that satisfies a mapping cycle threshold.

15. The UE of claim 1, wherein a third subset of ROs within the first subset of ROs occur after an integer number of association periods associated with the first subset of ROs.

16. The UE of claim 15, wherein:
ROs in the third subset of ROs are not non-mapped to synchronization signal block (SSB) transmissions and are not available for PRACH transmissions.

17. The UE of claim 15, wherein ROs in the third subset of ROs are available for PRACH transmissions in accordance with the first subset of ROs satisfying a mapping cycle threshold.

18. A method for wireless communications at a user equipment (UE), comprising:
receiving a signal that identifies a configuration for a set of physical random-access channel (PRACH) occasions (ROs), wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs; and
selectively performing one or more PRACH transmissions during the first subset of ROs according to the one or more first parameters.

19. The method of claim 18, wherein at least one RO of the additional ROs comprises at least one sub-band full duplex (SBFD) symbol.

20. A user equipment (UE) for wireless communications, comprising:
means for receiving a signal that identifies a configuration for a set of physical random-access channel (PRACH) occasions (ROs), wherein one or more first parameters associated with a first subset of ROs in the set of ROs are in accordance with one or more second parameters associated with a second subset of ROs in the set of ROs, wherein the first subset of ROs comprise additional ROs and the one or more first parameters comprise at least an association period associated with the first subset of ROs; and
means for selectively performing one or more PRACH transmissions during the first subset of ROs according to the one or more first parameters.
